(19) United States
(12) Patent Application Publication
(10) Pub. No.: US 2006/0122776 A1
(43) Pub. Date: Jun. 8, 2006

(54) Backtrack orbit search algorithm

(76) Inventors: Kenneth W. Knowles, Boulder, CO (US); Ross S. Swick, Boulder, CO (US)

Correspondence Address: Kenneth W. Knowles, 2444 6th Street, Boulder, CO, 80304, US

(21) Appl. No.: 11/004,195

(22) Filed: Dec. 3, 2004

(51) Int. Cl. G01C 21/26

(52) U.S. Cl. 701/226

(57) ABSTRACT

A method of searching an inventory of satellite remote sensing data for data granules, scenes, or images that cover a specified area of interest whereby each data granule is indexed to the relevant ascending equatorial crossing of the satellite. Representative points in the area of interest are traced backwards along the orbital track to determine where the satellite must have crossed the equator on the ascending pass in order for the sensor to have seen the area of interest. Spatial search of the data is thereby reduced to a simple search on a range of crossing longitudes.

### STATEMENT OF GOVERNMENT RIGHTS

The present invention was made with support from the U.S. government under NASA Grant Nos. NASA/NAG8-1093 and NASA/NAS5-98070. The government has certain rights in the invention.

### REFERENCE TO COMPUTER PROGRAM LISTING APPENDIX

A portion of the disclosure of this patent document is submitted on one compact disc and is hereby entirely incorporated herein by reference. The compact disc contains one file, created on Dec. 4, 2003, which is named “orbit.java” and is 47 kilobytes in size. An additional duplicate compact disc with the same file is also included for a total of two compact discs.

### COPYRIGHT NOTICE

Contained herein is material, including source code, which is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright© 2003, All Rights Reserved.

### BACKGROUND OF THE INVENTION

1. Field of the Invention

The present invention relates generally to a method for searching an inventory of orbital data captured by satellite born imaging sensors for records covering a specified area on the Earth. More particularly, the invention relates to a need the Earth Science community has for an efficient and accurate method of spatially searching for orbital data.

2. Background Art

Scientists studying climate change are able to make use of remotely sensed data to study any location on the Earth without having to go to the location to take measurements. As the quantity of available data increases it is increasingly important to be able to acquire only the relevant data, and for regional studies that means spatial search of the inventory.

Orbital data has historically been the most difficult type of data to search spatially primarily because there is no easy way to define the coverage of the records in the inventory. A single orbit will typically cross all lines of longitude and most lines of latitudes. If the field of view of the sensor is wide enough the data will cover all longitudes and all latitudes, but only a small portion of the Earth's surface. Consequently the mainstay of spatial search, the lat/lon bounding box, is not applicable. And because of the size of the data simply defining the location of every point is not practical.

Methods currently in use include the use of lookup tables, and the use of orbit propagators, to facilitate the indexing and search of orbital data. One quite sophisticated lookup table method is called Nominal Orbit Spatial Extent (NOSE) and a paper on how NOSE was adapted to work for Geoscience Laser Altimeter System (GLAS) data is available at http://edhs1.gsfc.nasa.gov/waisdata/sdp/pdf/tp1601401.pdf. No concise description of an orbit propagator method could be found but a brief description appears below.

The NOSE method works by predefining a set of nominal orbits, called tracks, and breaking each track into a set of predefined areas, called blocks. A typical implementation might define 360 tracks with 36 blocks in each. This information is loaded into a lookup table and the data in the inventory is indexed to the track ID of the nominal orbit it most closely resembles and/or the block IDs that overlap the coverage of the data. Traditional spatial search methods can then be run against the coverage of the blocks and spatial search of the inventory turns into a search on IDs.

The primary problem with lookup table methods is they are expensive to implement and, because the lookup tables are sensor specific, that cost is multiplied by the number of sensors using the system. Even discounting the cost the system is both inaccurate and slow. The typical implementation mentioned above results in a lookup table with 12,960 blocks to achieve 1 degree accuracy in longitude and only 10 degrees accuracy in latitude. Greater accuracy requires a larger lookup table, which is undesirable because each block must be spatially compared to the search area and spatial comparisons are computationally intensive so even traditional methods are slow.

Orbit propagator methods work by initializing an orbit model with the ephemeris data for a satellite at a specific time and spinning the model forward to predict when the sensor would have seen the search area. Consequently spatial search of the inventory is turned into a temporal search on a set of discrete times.

Orbit propagator methods are quite popular and several software packages are available at no charge to facilitate implementation. The addition of new satellites and sensors typically entails just an update to the software and because the propagator initializes with the actual ephemeris of the satellite the method is extremely accurate.

The primary problem with orbit propagator methods is performance diminishes rapidly as the temporal range of the search increases. Typical implementations often limit the search to a maximum of 180 days for this reason, but scientists studying climate change frequently want data for a number of years or even decades. While the propagator itself may be quite fast there is a linear relationship between the amount of time the propagator takes and the length of the temporal range of the search. Moreover the output from the propagator is a set of hundreds, even thousands, of discrete times to search on, which causes the subsequent inventory search to be slow.

### BRIEF SUMMARY OF THE INVENTION

It is an object of the present invention to provide a novel method for spatially searching an inventory of orbital data.

It is another object of the present invention to accomplish this search without using sensor specific lookup tables.

It is yet another object of the present invention to provide a time independent spatial search method.

It is yet another object of the present invention to reduce the inventory search to a search on a minimal number of longitude ranges.

It is yet another object of the present invention to provide a level of search accuracy that is limited only by the stability of the orbit of the satellite, and not by any factors intrinsic to the method itself.

### BRIEF DESCRIPTION OF THE DRAWINGS

FIG. 1 is a high level block diagram of an exemplary method.

FIG. 2 is an illustration of the similar spherical triangles used to determine the ascending equatorial crossing of a satellite that passes over the point of interest on the ascending pass.

FIG. 3 is an illustration of the difference between the cross track half swath width and the longitudinal half swath width.

FIG. 4 is an illustration of the similar spherical triangles used to determine the ascending equatorial crossing of a satellite that passes over the point of interest on the descending pass.

FIG. 5 is a high level block diagram of a computer architecture usable with the present invention.

### DETAILED DESCRIPTION

The present application claims priority from and fully incorporates herein, U.S. provisional patent application Ser. No. 60/527,206 entitled “BACKTRACK ORBIT SEARCH ALGORITHM”, filed on Dec. 5, 2003.

In the following description, numerous specific details are set forth. However, it is understood that embodiments of the invention may be practiced without these specific details. In other instances, well-known circuits, structures and techniques have not been shown in detail in order not to obscure the understanding of this description.

### OVERVIEW

Disclosed is a method, system, and program for retrieving records matching specified area search criteria from an information storage system containing records describing images acquired by a satellite born imaging sensor. The method tracks the satellite orbit backwards from the given search area to a set of longitude intervals on the equator without the use of lookup tables or regularly updated ephemeris and solely by means of mathematical equations and parameters given once for each different sensor. The intervals are derived once per search area without regard to the number of records in the information storage system or the total time interval spanned by the stored records. The information storage system records contain a crossing longitude for each image. The system returns record locators for all images with crossing longitudes that fall within the mathematically derived longitude intervals. The method is applicable to all sensors with a fixed field of view on board satellites that travel in an orbit with constant.

Broadly stated, an exemplary method may include receiving information that is indicative of a geographical location, using the information to select one or more satellite images that are associated with the geographical location based on an orbit path of a satellite, and optionally providing one or more of the selected images (e.g., by transmission over the Internet or another computer network, by post, or by other approaches known in the arts). Alternatively, rather than images, image identification information to identify one or more of the selected images may-optionally be provided.

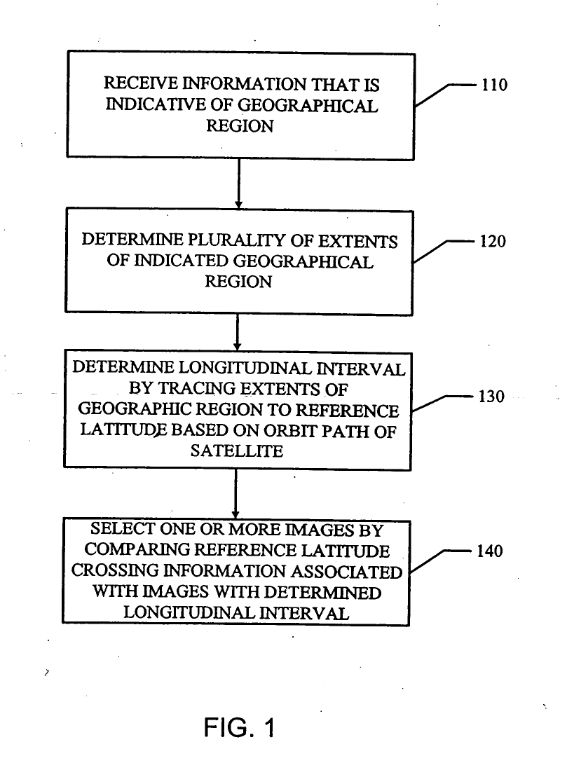

FIG. 1 shows a block diagram of an exemplary method of selecting one or more satellite images that are associated with the geographical location based on an orbit path of a satellite, according to one aspect. Other methods are also contemplated.

Information that is indicative of a geographical region may be received, at block 110. The information indicative of the geographical location may include, but is not limited to, one or more latitude and longitude coordinates, a state, a county, a city, a zip code, a quadrant, an address, and the like. The information may be sufficient to identify a location or region on the earth.

Then, a plurality of extents of the indicated geographical region may be determined, at block 120. For example, longitudinal extents of the geographical region may be determined.

Then, a longitudinal interval may be determined, at block 130, by tracing the extents of the geographic region to a reference location, such as a reference latitude, such as the equator, based on an orbit path of a satellite. The satellite may be associated with the geographical region and may have orbit characteristics as qualified elsewhere herein. The interval may have the characteristics that satellites that passed directly over the interval also passed directly over the region of interest, and may also have the characteristic that satellites that did not pass directly over the interval also did not pass directly over the region of interest. The longitudinal interval may be determined manually by tracing back on a map, or globe. However, often it may be advantageous to automate the tracing back by employing software, equipped with spherical trigonometric equations to autonomously perform the tracing back. Such a software and equation implementation is disclosed below, although not required to implement the invention.

Next, one or more images may be selected, based on the determined longitudinal interval, at block 140. For each of a plurality of satellite images, taken by a plurality of satellites, a determination may be made whether a reference latitude crossing location associated with each of the images lies within the determined longitudinal interval. The reference latitude crossing location may be associated with the image by a header, a record, or other approaches. The reference latitude crossing location generally indicates the location where the satellite taking the particular image crossed the reference latitude. In one aspect, the reference latitude may include the equator, since a commonly available reference latitude crossing location for satellites is an equatorial crossing location. An exemplary equatorial crossing location includes a longitude where a satellite crossed the equator on ascent (going from the southern hemisphere to the northern hemisphere). Such equatorial crossing location information may be stored directly for images taken by satellites or may be determined by well-known methods.

The crossing information for the images may be compared to the determined longitudinal interval in order to select a subset of the plurality of satellite images. Images may be selected if their latitude crossing locations lie within the determined longitudinal interval. A simple database query may often be employed to make such comparison and determination based on existing latitude crossing location fields set up for the plurality of images.

As discussed above, if desired, the one or more of the selected images may be provided. In one aspect, the methods may be employed in a computer network environment, where a client, or other remote networked appliance, provides information indicating a geographic location to a server, and the server selects and optionally provides one or more satellite images.

### DEFINITIONS

In this example, the following definitions will be used:

The path on the sphere that is directly below the satellite is the ground track.

The point directly below the satellite at a given moment is nadir.

The nadir point as the satellite crosses a given reference latitude is the nodal crossing.

The heading of the satellite as it crosses the equator on the ascending pass is the inclination.

The distance from the pole to the satellite as it passes closest to the pole is the declination. This is (inclination—90).

The amount of time the satellite takes to complete one orbit is the period.

The width of the field of view of the sensor is the swath width.

The highest point achieved by a given orbit is the inflection point. This is the point at which the orbit goes from ascending to descending.

The highest latitude achieved by an orbit, the latitude of the inflection point, is the inflection latitude. This is (90—declination).

The lowest latitude covered by a swath, when the satellite is at the point of inflection, is the minimum inflection latitude. It is the latitude of the left swath edge when the satellite is at the point of inflection.

The highest latitude covered by a swath, when the satellite is at the point of inflection, is the maximum inflection latitude. It is the latitude of the right swath edge at the point of inflection. We make this a circular latitude—it could be greater than 90 if the swath covers the pole. So max_inflection_lat=(inflection_lat+(inflection_lat−min_inflection_lat)).

The latitude above which all orbits cover the area is the total coverage latitude. Not all sensors have this. Sensors with a narrow swath never see the pole. So total_coverage_lat=min(90, (180—max_inflection_lat)

The latitude above which no orbits cover the area is the maximum coverage latitude. Not all sensors have this. Sensors with a wide swath see the pole on every pass. So max_coverage_lat=min(90, max_inflectior_lat)

Detailed Example

Given an area of interest and the period, inclination, and swath width of a sensor on a satellite, find all ascending equatorial crossings of the satellite for all orbits of the satellite during which the sensor recorded data over the point of interest.

0) Break the Area of Interest into Sample Points

The algorithm works on points so given an area create a set of sample points representative of the area. We sample points along the perimeter that are less than width/2 apart but other sampling schemes could be used. It is helpful if the sample points are close enough so the resulting crossing ranges will overlap and hence may be merged into one searchable crossing range. Perimeter points are a good choice because that's where the extremes of the area are. I.e. any swath that includes an interior point of the area must also include a perimeter point. Operations 1-6 may be repeated for each sample point then the crossing ranges may be merged prior to the search.

1) Find the Prbit with Nadir Crossing the Given Point

Let the point of interest be (latₚ, lonₚ). We seek the ascending equator crossing point of nadir at (0, lonₙ).

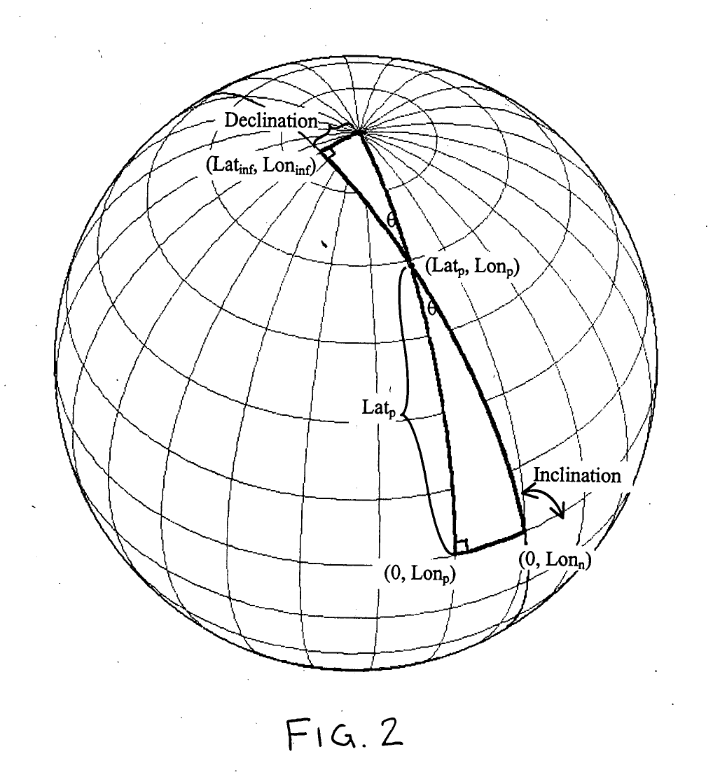

FIG. 2 Illustrates the Concepts, According to One Aspect.

First consider a static (non-rotating) sphere. Given (latₚ, lonₚ) we may construct a great circle. Because we know the inclination of the orbit we know the maximum latitude of the orbit so we may construct the great circle that passes through (latₚ, lonₚ) and has it's inflection point at (lat_{inf}, lon_{inf}). That great circle and the longitude line of the point of interest intersect at the point of interest. Using those two great circles, the equator, and the longitude segment from the pole to the inflection point (lat_{inf}, lon_{inf}) we may create two spherical triangles. We know the latitude of the inflection point is (90—declination) where declination=(inclination-90) so we know the length of the great circle arc along lon_{inf} that connects the inflection point to the pole is equal to the declination.

Given a spherical triangle with sides α, β, and χ and opposite interior angles A, B, and X the Law of Sines for spherical triangles is:
sin(α)/sin(A)=sin(β)/sin(B)=sin(χ)/sin(X)

Let θ be the angle between the longitude of the point and the orbital great circle. Then by the Law of Sines
sin(90−lat_{inf})/sin(θ)=sin(90−latₚ)/sin(90) so
sin(θ)=sin(90−lat_{inf})/sin(90−latₚ)
Similarly
sin(lonₙ−lonₚ)/sin(θ)=sin(latₚ)/sin(lat_{inf}) so
sin(lonₙ−lonₚ)=sin(θ)*sin(latₚ)/sin(lat_{inf}) so
lonₙ=a sin(sin(θ)*sin(latₚ)/sin(lat_{inf}))+lonₚ

Similarly we may find the length of the arc between (0, lonₙ) and (latₚ, lonₚ)
sin(L_{arc})/sin(90)=sin(latₚ)/sin(lat_{inf}) so
L_{arc}=a sin(sin(latₚ)/sin(lat_{inf}))

The true equatorial crossing may be found by adjusting for the rotation of the Earth during the time it takes the satellite to travel the distance of L_{arc}.
RealLonₙ=lonₙ+[period*L_{arc}*ROTATION_RATE/circumference]

Eventually we'll want to adjust everything by that amount—but for now we still need to use the static sphere.

2) Convert to Cartesian Space and Find the Orbital Plane.

These two points (latₚ, lonₚ) and (latₙ, lonₙ) lie on the Great Circle that is the orbit. Combined with the origin they define a plane.

Convert to Cartesian
x=r*cos(lon)*cos(lat);
y=r*sin(lon)*cos(lat);
z=r*sin(lat);

The plane of the Great Circle is defined by:
(yₚZₙ−yₙzₚ)x−(xₚzₙ−xₙzₚ)y+(xₚyₙ−xₙyₚ)z=0
Let
a=(yₚzₙ−yₙzₚ)
b=−(xₚzₙ−x_{z}zₚ)
c=(xₚyₙ−xₙyₚ)

So in Cartesian space the plane of the orbit on a static sphere is: ax+by+cz=0

3) Find Points on the Swath Edges:

Given the swath width find points (lat_{edge}, lon_{edge}) on each edge by going half that distance perpendicular to the ground track. This only works for downward looking sensors. Forward looking and backward looking sensors may also use this method by creating a virtual satellite that is downward looking. For side viewing sensors simply dividing the swath width in half doesn't work. Instead the swath width may be broken apart into left and right distances from nadir.

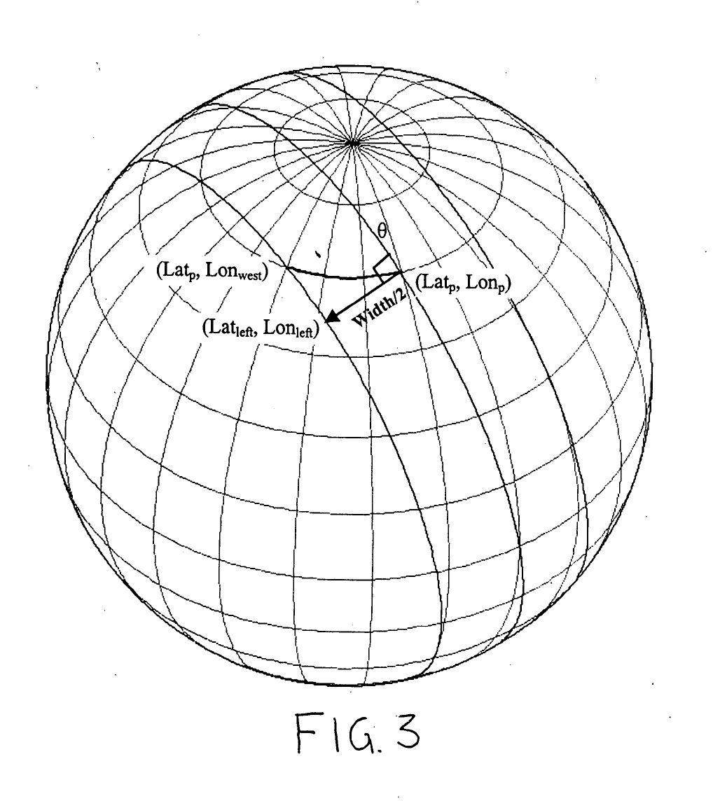

FIG. 3 Illustrates the Concepts, According to one Aspect.

For the left edge of the swath we find the point (lat_{left}, lon_{left}) that is a distance (width/2) from the point of interest (latₚ, lonₚ) along the heading (180+θ).
lat_{left}=a sin((sin(latₚ)*cos(width/2))+(cos(latₚ)*sin(width/2)*sin(180+θ)))
lon_{left}=lonₚ−a cos((cos(width/2)−sin(latₚ)*sin(lat_{left}))/(cos(latₚ)*cos(lat_{left})))

For the right edge of the swath we need to find the point (lat_{right}, lon_{right}) that is distance (width/2) from the point of interest (latₚ, lonₚ) along the heading (θ).
lat_{right}=a sin((sin(latₚ)*cos(width/2))+(cos(latₚ)*sin(width/2)*sin(θ))
lon_{right}=lonₚ+a cos((cos(width/2)−sin(latₚ)*sin(lat_{right}))/(cos(latₚ)*cos(lat_{right})))
4) Find the Planes of the Swath Edges:

Convert the edge point to Cartesian (x_{edge}, y_{edge}, z_{edge}).

On a static sphere the swath edge is a small circle parallel to the Great Circle defined by nadir. In Cartesian space that defines a plane parallel to the plane ax+by+cz=0

That plane is: ax+by+cz=d where d=(ax_{edge}+by_{edge}+cz_{edge})

And the equation for the plane of the small circle which is the other edge of the swath is:
ax+by+cz=−d
5) Find the Intersects with the Given Latitude:

We want the points where each small circle intersects the latitude of the given point, and the sphere. That is:
ax+by+cz=d: swath edge
x²+y²+z²=r²: sphere
z=zₚ: lat=latₚ

Three equations and three unknowns. We're keeping the latitude constant so we only care about the longitude which is arctan(y/x). Substituting z=zₚ and rearranging we get:
ax+by+czₚ−d=0 and
x²−y²+zₚ²−r²=0

Grouping the constants together simplifies the process of solving the equations.
P=czₚ−d (Constants in the Plane equation)
S=zₚ²−r² (Constants in the Sphere equation)

Which gives us two equations and two unknowns.
ax+by+P=0 and
x²+y²+S=0

Solved for x and y
x=(−P+(b²P/(a²+b²)−(b*sqrt[−a⁴S−a²b²S−a²P²]/(a²+b²)/a)
and,
y=(−bP+Sqrt[−(a⁴S)−a²b²S−a²P²])/(a²+b²)
or,
x=(−P+(b²P/(a²+b²)+(b*Sqrt[−a⁴S−a²b²S−a²P²]/(a²+b²))/a)
and,
y=(−bP−Sqrt[−(a⁴S)−a²b²S−a²P²])/(a²+b²)

Convert back to spherical coordinates to get the longitudes:
lon=arctan(y/x)

There are at most two solutions for each edge of the swath. Of the four possible solutions we need the closest two, one east, one west. The other two are where the planes of the swath edges cross the latitude on the other side of the sphere.

6) Find Crossings for the Extrene Orbits:

Find the distance, in longitude, from the original point to the edge points (adjusted for the dateline). Let:
D_{E}=lonₑₐₛₜ−lonₚ
D_{W}=lonₚ−lon_{west}

Find the point D_{E} west of (latₚ, lonₚ), which is (latₚ, lonₚ−D_{E}), and the point D_{W} east of (latₚ, lonₚ), which is (latₚ, lonₚ+D_{W})

Note: An error is introduced into the algorithm here. The sensor will see the points (latₚ, lonₚ−D_{E}) and (latₚ, lonₚ+D_{W}) some time prior to, or after, it passes over (latₚ, lonₚ). To be more accurate we should adjust for the rotation of the Earth during the intervening time. But the error is always small and adjusting for it means taking the sensor geometry into account. So we tolerate it in an effort to keep the algorithm simple. Still, we may adjust at this point using some “generic” sensor geometry to increase the accuracy somewhat without sacrificing the generality of the algorithm. One example is outlined below.

Find the nodal crossing of the orbit (on a rotating earth) that passes through (latₚ, lonₚ−D_{E}) using operation 1 above and call it lon_{nadirWest}. For any orbit of this satellite with a nodal crossing at lon_{nadirWest} the sensor sees the given point (latₚ, lonₚ) on the east edge of the swath during the ascending pass.

Find the nodal crossing of the orbit (on a rotating earth) that passes through (latₚ, lonₚ+D_{W}) using operation 1 above and call it lon_{nadirEast}. For any orbit of this satellite with a nodal crossing at lon_{nadirEast} the sensor sees the given point (latₚ, lonₚ) on the west edge of the swath during the ascending pass.

For any orbit of this satellite with a nodal crossing in the range [lon_{nadirWest}, lon_{nadirEast}] the sensor sees the given point (latₚ, lonₚ)

7) Merge the Ranges Found in Operations 1-6

Each sample point created in operation 0 produces a crossing range and if the samples were close enough those ranges should overlap. Consequently they may be merged into a single crossing range that defines where the satellite must have crossed the equator on the ascending pass if the sensor were to see the area of interest during the ascending pass.

8) Query the Database or Other Information Storage System.

The crossing range may be used to create a spatial clause that searches on crossings in a database query. For our database that clause looks like this:
where nodal_crossing between (lon_{nadirWest}, lon_{nadirEast})

Combined with other clauses (temporal, parameter, quality flags, etc.) a single, relatively small, query is sufficient to return record locators matching the specified criteria.

Descending Passes

To find the ascending crossing range for orbits during which the sensor would see the area of interest on the descending pass the algorithm is similar with some minor adjustments.

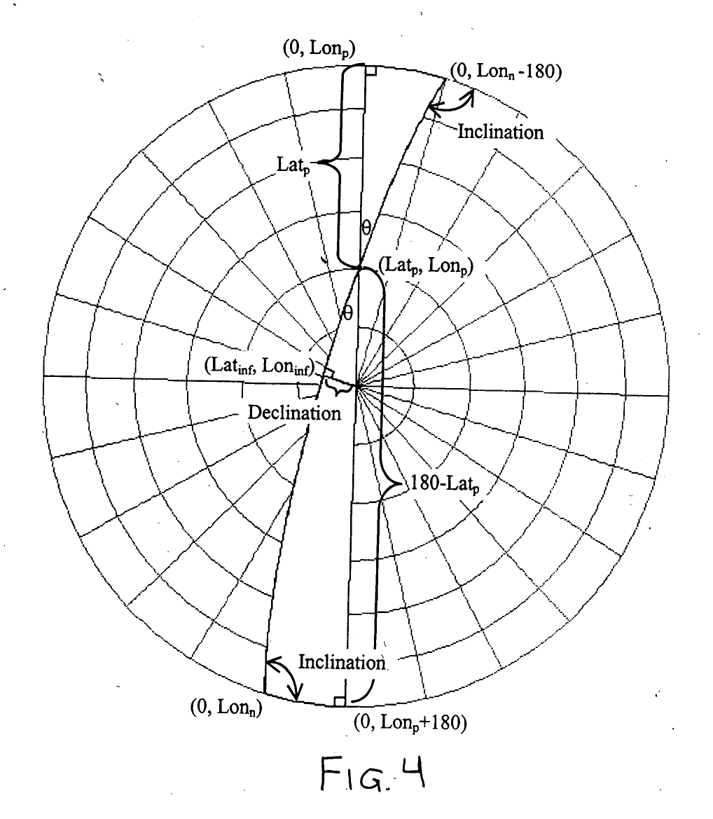

FIG. 4 Illustrates the Concepts, According to One Aspect.

The angle θ may be found the same way—but the point of interest is now on the opposite side of the sphere as the ascending crossing so adjustments have to be made.
sin(lonₚ−(lonₙ−180))/sin(θ)=sin(latₚ)/sin(lat_{inf})
sin(lonₚ+180−lonₙ)/sin(θ)=sin(latₚ)/sin(lat_{inf})
sin(lonₚ+180−lonₙ)=sin(θ)*sin(latₚ)/sin(lat_{inf})
lonₚ+180−lonₙ=a sin(sin(θ)*sin(latₚ)/sin(lat_{inf}))
lonₙ=lonₚ+180−a sin(sin(θ)*sin(latₚ)/sin(lat_{inf}))
lonₙ=lonₚ+180−a sin(sin(θ)*sin(latₚ)/sin(lat_{inf}))

Similarly we may find the length of the arc between (0, lonₙ) and (latₚ, lonₚ) by finding the length of the arc between (0, lonₙ—180) and (latₚ, lonₚ) and subtracting from the length of the half great circle.
sin(L_{arc})/sin(90)=sin(latₚ)/sin(lat_{inf}) so
L_{arc}=a sin(sin(latₚ)/sin(lat_{inf}))

The true equatorial crossing may be found by adjusting for the rotation of the Earth during the time it takes the satellite to travel the distance of 180−L_{arc}.
RealLonₙ=lonₙ+[period*(180−L_{arc})*ROTATION_RATE/circumference]
Correcting the Longitudinal Half Swath Widths

The radius of the small circle that defines the swath edge is proportional to the radius of the sphere by the cos of the angular distance (distance on the sphere) from the parallel great circle. That is: radius_{sc}=radius*cos(distance)

The distance between two points in Cartesian space is sqrt((x₁−x₂)²+(y₁−y₂)²+(z₁−z₂)²) so the distance between left edge point and the west edge point is:
D=sqrt((x_{left}−x_{west})²+(y_{left}−y_{west})²+(z_{left}−z_{west})²)

Those two points, and the center of the small circle, create an isosceles triangle in the plane of the small circle. We may use ordinary Euclidean trigonometry to find the vertex angle of that triangle and hence the length of the arc on the small circle.
cos(v)=(2*radius_{sc}²−D²)/2*radius_{sc}²=1−(D²/2*radius_{sc}²)
v=a cos(1−(D²/2*radius_{sc}²))

The correction would be the distance the earth rotated in the time it took the satellite to go v degrees.

The correction for the right/east edge may be found in a similar fashion. One must keep in mind that Earth rotates east to west, so on the ascending pass the sensor sees the west edge point sometime after the satellite passes over the point of interest, but it sees the east edge point sometime before the satellite passes over the point of interest.

Special Cases

1) The absolute value of the latitude of the point of interest is greater than the maximum coverage latitude. If the point of interest is above (or below) the maximum coverage latitude the sensor never sees that point so the algorithm returns with no results. If every sample point in the area interest is above (or below) the maximum coverage latitude it's no use even running the search.

2) The absolute value of the latitude of the point of interest is greater than the total coverage latitude. If the point of interest is above (or below) the total coverage latitude the sensor sees that point during every orbit and the algorithm returns a crossing range of [0, 360]. Once that happens there is no need to test further sample points and really no need for a crossing range clause in the search, every orbit is a match.

3) The absolute value of the latitude of the point of interest is greater than the minimum inflection latitude. If the point of interest is above (or below) the minimum inflection latitude it means one of the swath edges is not present at that latitude making it impossible to find the longitudinal half swath width. Since the algorithm distinguishes between ascending and descending passes the cutoff in either direction is the longitude of the inflection point.

4) The absolute value of the latitude of the point of interest is greater than the inflection latitude. If the point of interest is above (or below) the inflection latitude, and didn't qualify for cases 1 or 2 above, it is never the case that the satellite passes over the point but there is still a limited range of crossings for which the sensor will see the point. The algorithm may still use the point itself to find the longitudinal half swath widths (with appropriate cutoffs as noted in case 3) but needs to substitute the inflection latitude for the latitude of the point in order to find the initial cross track edge points and the crossings.

Variations

Forward and Backward Looking Sensors

The algorithm as described above assumes a downward looking sensor. As mentioned above the algorithm could be adjusted to work with forward and backward looking sensors by creating a virtual satellite. Technically the algorithm doesn't care where the satellite is; it cares where the data is. If a sensor is pointed x degrees forward of the satellite location that is functionally equivalent to a downward looking sensor on a virtual satellite x degrees ahead. Because the Earth rotates during the time it takes the satellite to travel x degrees the inclination of the virtual satellite may be slightly different from the inclination of the real satellite so that adjustment to the input parameters needs to be made.

One unfortunate side effect is that orbits are often defined by where the satellite is, so the orbital data from a sensor looking x degrees forward may start and end at x degrees north latitude instead of at the equator. One may adjust for this by recording the start/end circular latitude (discussed below) in the inventory and incorporating that into the search. Or one could avoid storing those extra fields in the inventory for each and every orbit by adjusting the algorithm to use x degrees north as the reference latitude.

Side Viewing Sensors

It was also mentioned above that the algorithm could easily be adjusted to work for side viewing sensors. As described the algorithm assumes the ground track of the satellite (nadir) is in the center of the swath, so the distance to the left and right edges of the sensors field of view is just half the swath width. To accommodate side viewing sensors we just have to be more explicit about those distances. Instead of just the swath width as input we would need the two distances from nadir to the swath edge.

For example a sensor with a 1400 kilometer wide swath centered 200 kilometers left of nadir would have left and right distances of 900 kilometers and 500 kilometers respectively. The same sensor at a more extreme angle, centered 800 kilometers left of nadir, would have left and right distances of 1500 kilometers and −100 kilometers respectively where the negative value of the right distance indicates the right edge of the swath is actually left of nadir. The sign is a matter of convention and one may adopt whatever convention is convenient.

Partial Orbits

The algorithm as described assumes full orbits that start and end at the same reference latitude, but sometimes it is more practical to slice the data into partial orbits which means the start and end of the data become important. While the orbit the data is part of may intersect the area being searched the data itself may not. Unfortunately just the geographic location isn't sufficient, the direction of the satellite is also significant. To combine the start/end latitude of the data with the direction of the satellite into a single number we have adopted a convention of circular latitudes. Starting at the equator the circular latitudes are [0, 90] ascending, [90, 270] descending, and [270, 360] ascending. Care must be taken to ensure the circular latitudes are in sync with the indexed crossing of the data. For example an descending half orbit that starts at it's northernmost point and ends at it's southernmost point, for a satellite with an inclination of 98.78 degrees, indexed to the previous ascending crossing, would have start/end circular latitudes of {98.78, 261.22}. The same half orbit indexed to the next ascending crossing would have start/end circular latitudes of {−261.22, −98.78}. And an ascending half orbit indexed to the included ascending crossing would have start/end circular latitudes of {−81.22, 81.22}.

Multiple Orbits

It is also sometimes convenient to include more than one orbit in a data granule and circular latitudes may also be used to compensate. For example a two orbit granule, that starts/ends on the equator during the ascending pass, indexed to the initial ascending crossing would have start/end circular latitudes of start/end circular latitudes of {0, 720}. Indexed to the included ascending crossing the start/end circular latitudes would be {−360, 360}. And indexed to the ending ascending crossing the start/end circular latitudes would be {−720, 0}

The algorithm may compensate accordingly by computing the start/end circular latitudes of the search area for the different possibilities and creating multiple clauses for the search. To keep the algorithm general some indication of how many orbits are in each granule, and which crossing the granules are indexed to, should be added as an input parameter. One possible convention is to always index to the first included ascending crossing, or the previous ascending crossing if none are included (as with descending half orbits), and indicate the number of orbits in each granules with a single floating point number as an input parameter.

Lookup Tables

One advantage of the algorithm is it figures out everything mathematically rather than using lookup tables. This makes it faster, more flexible, more accurate, and less expensive. It's faster because every database query takes a certain amount of time just to initialize which is often orders of magnitude larger than the amount of time it takes to compute the answer. It's more flexible because changes in the orbit of a satellite may be accommodated by adjusting a few input parameters rather than recreating an entire lookup table. This is especially true during the pre-launch timeframe when people are preparing the system. Efforts expended creating lookup tables prior to launch may be wasted if the satellite doesn't achieve the expected orbit.

The backtrack algorithm is also demonstrably more flexible in adding another sensor to the system. Instead of requiring a new lookup table for each new sensor, which are costly to create and, depending on the desired accuracy, may be quite large, the algorithm requires only the addition of a few input parameters in a single row of an existing table. Moreover the accuracy of lookup table methods is directly related to the size of the table. Depending on context doubling the accuracy of a lookup table may mean doubling, or quadrupling, its size, which not only increases the storage but also increases the time it takes to query the table. The backtrack algorithm, on the other hand, starts out as accurate as the input parameters and the computations allow.

Finally it would appear that one has to do the math in order to create the lookup tables in the first place. So actually going ahead with the creation and use of the lookup tables is extra effort. Often that effort is deemed necessary because the orbital mechanics and spherical trigonometry involved in doing the math are quite complex, prone to error during the coding process, and computationally expensive. But the backtrack algorithm simplifies the orbital mechanics by limiting itself to circular orbits and simplifies the math involved by using a hybrid of spherical trigonometry, Cartesian solid Geometry, Euclidean planar Geometry, and simple Algebra.

Still, there are places in the algorithm where lookup tables could be used. The longitudinal half swath widths, for example, are constant for a given latitude and direction. The correction due to the rotation of the Earth of the longitudinal half swath widths is also constant for a given latitude and direction. If the desired accuracy is such that the lookup table would be small a search for corrected widths based on latitude and direction might be faster than doing the math.

Alternatively the entire algorithm, or pieces of it, could be used to generate lookup tables for legacy systems that require them. This has in fact been done for one sensor, which reduced the cost of generating the table by about 90%. And with a table generator written the costs associated with changing that table, or generating another for a different sensor, are virtually nothing.

Detailed Working Example

A detailed working example is attached as Appendix A, which is hereby incorporated by reference into this patent document.

Computer Program Listing Appendix

A paper copy of the computer program listing that has been submitted on compact disc is attached as Appendix B, which is hereby incorporated by reference into this patent document. The computer program listing may be run on a computer system, such as that described in the following section.

Exemplary Computer Architecture p As discussed herein, a “system” or “computer system” may be an apparatus including hardware and/or software for processing data. The system may include, but is not limited to, a computer (e.g., portable, laptop, desktop, server, mainframe, etc.), hard copy equipment (e.g., optical disk burner, printer, plotter, fax machine, etc.), and the like.

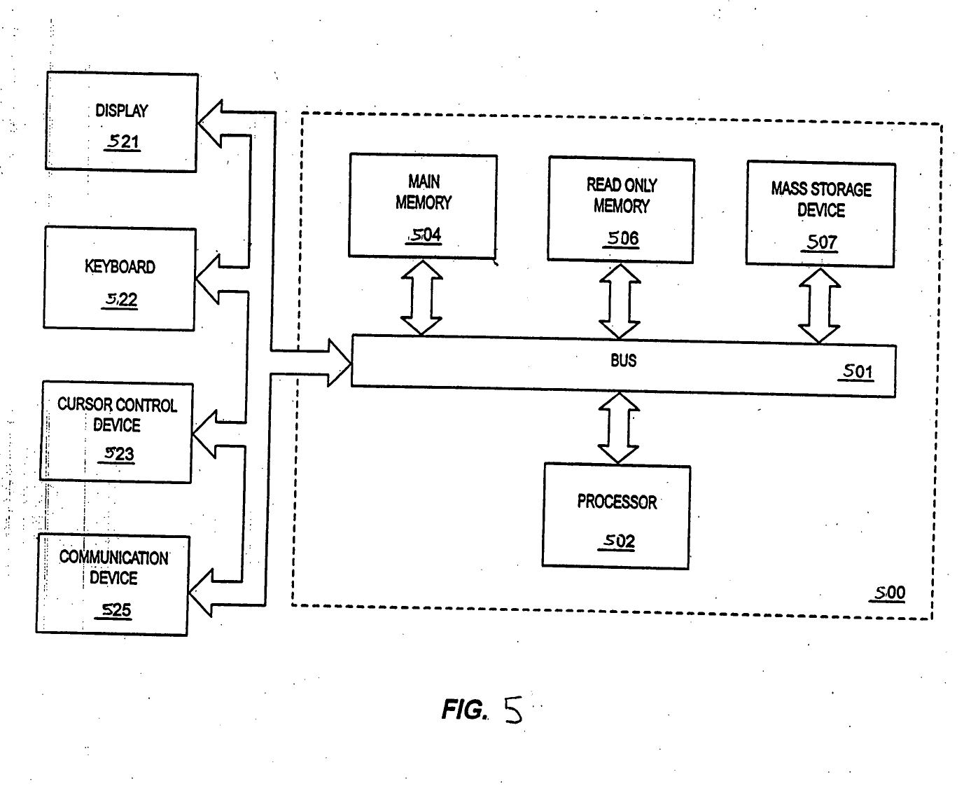

A computer system 500 representing an exemplary workstation, host, or server in which features of the present invention may be implemented will now be described with reference to FIG. 5. The computer system 500 represents one possible computer system for implementing embodiments of the present invention, however other computer systems and variations of the computer system 500 are also possible. The computer system 500 comprises a bus or other communication means 501 to communicate information, and a processing means such as processor 502 coupled with the bus 501 to process information. The computer system 500 further comprises a random access memory (RAM) or other dynamic storage device 504 (referred to as main memory), coupled with the bus 501 to store information and instructions to be executed by the processor 502. The main memory 504 also may be used to store temporary variables or other intermediate information during execution of instructions by the processor 502. In one embodiment, the main memory 504 may be used to store the operating system, application programs, predetermined coded instructions, rule sets, data structures, and other types of data. The computer system 500 also comprises a read only memory (ROM) and other static storage devices 506 coupled with the bus 501 to store static information and instructions for the processor 502, such as the BIOS. A data storage device 507 such as a magnetic disk, zip, or optical disc and its corresponding drive may also be coupled with the computer system 500 to store information and instructions.

The computer system 500 may also be coupled via the bus 501 to a display device 521, such as a cathode ray tube (CRT) or liquid crystal display (LCD), to display information to an end user. Typically, a data input device 522, such as a keyboard or other alphanumeric input device including alphanumeric and other keys, may be coupled with the bus 501 to communicate information and command selections to the processor 502. Another type of user input device is a cursor control device 523, such as a mouse, a trackball, or cursor direction keys, to communicate direction information and command selections to the processor 502 and to control cursor movement on the display 521.

A communication device 525 is also coupled with the bus 501. Depending upon the particular implementation, the communication device 525 may include a modem, a network interface card, or other well-known interface devices, such as those used for coupling to Ethernet, token ring, or other types of physical attachment for purposes of providing a communication link to support a local or wide area network, for example. In any event, in this manner, the computer system 500 may be coupled with a number of clients or servers via a conventional network infrastructure, such as a company's intranet, an extranet, or the Internet, for example.

Embodiments of the invention are not limited to any particular computer system. Rather, embodiments may be used on any stand alone, distributed, networked, or other type of computer system. For example, embodiments may be used on one or more computers compatible with NT, Linux, Windows, Macintosh, any variation of Unix, or others.

General Matters

In the description above, for the purposes of explanation, numerous specific details have been set forth in order to provide a thorough understanding of the embodiments of the invention. It will be apparent, however, to one skilled in the art, that other embodiments may be practiced without some of these specific details. In other instances, well-known structures, devices, and techniques have been shown in block diagram form or without detail in order not to obscure the understanding of this description.

An embodiment of the invention may include various operations. The operations of the embodiment may be performed by hardware components, or may be embodied in machine-executable instructions, which may be used to cause a general-purpose or special-purpose processor or logic circuits programmed with the instructions to perform the operations. Alternatively, the operations may be performed by a combination of hardware and software.

An embodiment of the invention may be provided as a program product or article of manufacture, which may include a machine-readable medium having stored thereon an instruction or instructions, which may be used to program a machine, computer system, electrical device, or other apparatus, to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, an embodiment of the invention may also be downloaded as a computer program product, wherein the program may be transferred from one computer to another computer by way of data signals embodied in a carrier wave or other propagation medium via a communication link (e.g., a modem or network connection).

Many of the methods are described in their most basic form, but operations may be added to or deleted from the methods. It will be apparent to those skilled in the art that many further modifications and adaptations may be made. The particular embodiments are not provided to limit the invention but to illustrate it. The scope of the invention is not to be determined by the specific examples provided above but only by the eventual claims.

It should also be appreciated that reference throughout this specification to “one embodiment” or “an embodiment”, or “one version”, etc. means that a particular feature may be included in the practice of the invention. Similarly, it should be appreciated that in the foregoing description of exemplary embodiments of the invention, various features are sometimes grouped together in a single embodiment, Figure, or description thereof for the purpose of streamlining the disclosure and aiding in the understanding of one or more of the various inventive aspects.

While the invention has been described in terms of several embodiments, those skilled in the art will recognize that the invention is not limited to the embodiments described, but may be practiced with modification and alteration. The description is thus to be regarded as illustrative instead of limiting.

### APPENDIX A

### DETAILED WORKING EXAMPLE

The Backtrack Orbit Search Algorithm:

Worked Example: Pittsburgh

The picture below is a relatively ordinary orbit for a polar orbiter. The ascending equatorial crossing is at 77.75E. The satellite has an inclination of 98.78 degrees (declination of 8.78 degrees) and a period of 101 minutes. The swath width is 1400 km.

[image]

We want to find all the orbits for which this sensor sees Pittsburgh on the ascending pass. Given the location of Pittsburgh (40.50, −80.22) the algorithm looks at what the swath would look like if the ground track of the satellite went right through Pittsburgh on the ascending pass.

1) Find the Orbit with Nadir Crossing the Given Point.
sin(θ)=sin(90−Lat_{inf})/sin(90−Latₚ)
sin(θ)=sin(8.78)/sin(49.5)0.15264/0.76041=0.2007
θ=11.5779
Lonₙ=a sin(sin(θ)*sin(Latₚ)/Sin(Lat_{inf}))+Lonₚ
Lonₙ=a sin(0.2007*sin(40.5)/sin(81.22))−80.22
Lonₙ=a sin(0.2007*0.64945/0.98828)−80.22
Lonₙ=a sin(0.13189)−80.22
Lonₙ=7.57883−80.22=−72.64117

Then correct for rotation
sin(length)/sin(90)=sin(latₚ)/sin(lat_{inf}) so
length=a sin(sin(latₚ)/sin(lat_{inf}))
length=a sin(sin(40.5)/sin(81.22))
length=a sin(0.64945/0.98828)
length=a sin(0.65715)
length=41.0830 degrees.

Which means the true equatorial crossing can be found by adjusting for the rotation of the Earth during the time it takes the satellite to travel 41.0830 degrees.
RealLonₙ=Lonₙ+[period*length*ROTATION_RATE/circumference]
RealLonₙ=−72.64117+[101*41.0830*(15/60)/360]
RealLonₙ=−72.64117+[101*41.0830*(15/60)/360]
RealLonₙ=−72.64117+2.8815
RealLonₙ=−69.75965

And if that's all we wanted we'd be done. But we need to find the crossings for all the orbits that cover Pittsburgh, which means we need to take the swath width into account, which means we need to go back to the static sphere.

2) Convert to Cartesian Space and Find the Orbital Plane.

The two points (latₚ, lonₚ) and (latₙ, lonₙ) lie on the Great Circle that is the orbit on the static sphere. Combined with the origin they define a plane.
x=r*cos(lon)*cos(lat);
y=r*sin(lon)*cos(lat);
z=r*sin(lat);

The radius is just a constant multiplier so we'll use a radius of 1.
xₚ=cos(lonₚ)*cos(latₚ)=cos(−80.22)*cos(40.5)=0.16986*0.76041=0.12916
yₚ=sin(lonₚ)*cos(latₚ)=sin(−80.22)*cos(40.5)=−0.98547*0.76041=−0.74936
zₚ=sin(latₚ)=sin(40.5)=0.64945
xₙ=cos(lonₙ)*cos(latₙ)=cos(−72.64117)*cos(0.0)=0.29836
yₙ=sin(lonₙ)*cos(latₙ)=sin(−72.64117)*cos(0.0)=−0.95445
zₙ=sin(latₙ)=sin(0.0)=0

The plane of the Great Circle is defined by:
(yₚzₙ−yₙzₚ)x−(xₚzₙ−xₙzₚ)y+(xₚyₙ−xₙyₚ)z=0
Let
a=(yₚzₙ−yₙzₚ)=(−0.74936*0)−(−0.95445*0.64945)=0.61987
b=−(xₚzₙ−xₙzₚ)=−((0.12916*0)−(0.29836*0.64945))=0.19377
c=(xₚyₙ−xₙyₚ)=(0.12916*−0.95445)−(0.29836*−0.74936)=−0.123277+0.22358=0.10030

And the plane of the orbit on a static Earth is: ax+by+cz=0

Sanity Check:
axₚ+byₚ+czₚ=(0.61987*0.12916)+(0.19377*−0.74936)+(0.10030*0.64945)=0.08006−0.14520+0.06514=0
axₙ+byₙ+czₙ=(0.61987*0.29836+(0.19377*−0.95445)+(0.10030*0)=0.18494−0.18494+0=0

[image]

3) Find Points on the Swath Edges:

We have the width in kilometers but we need to keep the units consistent. For this example we'll use 111 km/degree but you may want to be more precise.

width=1400/111=12.6126 degrees.

For the left edge of the swath we need to find the point (Lat_{left}, Lon_{left}) that is distance (width/2) from the point of interest (Latₚ, Lonₚ) along the heading (180+θ).
lat_{left}=a sin((sin(latₚ)*cos(width/2))+(cos(latₚ)*sin(width/2)*sin(180+θ)))
lat_{left}=a sin((sin(40.5)*cos(6.3063))+(cos(40.5)*sin(6.3063)*sin(191.5779)))
lat_{left}=a sin((0.64945*0.99395)+(0.7604*0.10984*−0.2007))
lat_{left}=a sin(0.6455+(−0.01676))
lat_{left}=a sin(0.62874)=38.957
lon_{left}=lonₚ−a cos((cos(width/2)−sin(latₚ)*sin(lat_{left}))/(cos(latₚ)*cos(lat_{left})))
lon_{left}=−80.22−a cos((cos(6.3063)−sin(40.5)*sin(38.957))/(cos(40.5)*cos(38.957)))
lon_{left}=−80.22−a cos((0.99395−0.64945*0.62874) (0.7604*0.77762))
lon_{left}=−80.22−a cos((0.99395−0.40834)/(0.5913))
lon_{left}=−80.22−a cos((0.58561481)/(0.5913))
lon_{left}=−80.22−a cos(0.990384)
lon_{left}=−80.22−7.952
lon_{left}=−88.1721

For the right edge of the swath we need to find the point (lat_{right}, lon_{right}) that is distance (width/2) from the point of interest (latₚ, lonₚ) along the heading (θ).
lat_{right}=a sin((sin(latₚ)*cos(width/2))+(cos(latₚ)*sin(width/2)*sin(θ))
lat_{right}=a sin((sin(40.5)*cos(6.3063))+(cos(40.5)*sin(6.3063)*sin(11.5779))
lat_{right}=a sin(0.64945*0.99395)+(0.7604*0.10984*0.2007)
lat_{right}=a sin(0.6455+0.01676)
lat_{right}=a sin(0.66226)=41.472
lon_{right}=lonₚ+a cos((cos(width/2)−sin(latₚ)*sin(lat_{right}))/(cos(latₚ)*cos(lat_{right})))
lon_{right}=−80.22+a cos((cos(6.3063)−sin(40.5)*sin(41.472))/(cos(40.5)*cos(41.472)))
lon_{right}=−80.22+a cos((0.99395−0.64945*0.66226)/(0.7604*0.74927))
lon_{right}=−80.22+a cos((0.99395−0.4301)/(0.7604*0.74927))
lon_{right}=−80.22+a cos(0.56384524/0.5697)
lon_{right}=−80.22+a cos(0.98964)
lon_{right}=−80.22+8.253=−71.967
4) Find the Planes of the Swath Edges:

Convert the edge points to Cartesian and then the planes of the swath edges are given by ax+by+cz=d.
x_{left}=cos(lon_{left})*cos(lat_{left})=0.031887*0.77762=0.02479
y_{left}=sin(lon_{left})*cos(lat_{left})=31 0.99949*0.77762=−0.77722
z_{left}=sin(lat_{left})=0.62874
x_{right}=cos(lon_{right})*cos(lat_{right})=0.30956*0.74928=0.23195
y_{right}=sin(lon_{right})*cos(lat_{right})=−0.95088*0.74928=−0.71247
z_{right}=sin(lat_{right})=0.66225

Perform a sanity check. The two points we found should be the same distance from the orbital plane.
ax_{left}+by_{left}+cz_{left}=d=−(ax_{right}+by_{right}+cz_{right})
(0.61987*0.02479)+(0.19377*−0.77722)+(0.10030*0.62874)=d=−((0.61987*0.23195)+(0.19377*−0.71247)+(0.10030*0.66225))
(0.015367−0.15060+0.06306)=d=−(0.14378−0.138055+0.06642)−0.07217=d=−0.07214

There's some cumulative rounding error, but it's pretty good.

5) Find the Intersects with the Given Latitude:

Now we have those planes we can find the points where the planes intersect the latitude of our point of interest. That is:
ax+by+cz=d: swath edge
x²+y²+z²=r²: sphere
z=zₚ: lat=latₚ

Three equations, three unknowns. We're keeping the latitude constant so we only care about the longitude which is a tan2(y, x). Substituting z=zₚ and rearranging we get:
ax+by+czₚ−d=0 and
x²−y²+z²−r²=0
Let
planar_const=czₚ−d=(0.10030*0.64945)−0.07215=0.0651398−0.07215=−0.007010
sphere_const=zₚ²−r²=0.64945²−1=0.42179−1=−0.57821
scale=(a²+b²)=(0.61987²+0.19377²)=0.42179
radical=Sqrt((−a⁴*sphere_const)−(a²*b²*sphere_const)−(a²*planar_const²))
radical=Sqrt((−0.61987⁴*−0.57821)−(0.61987²*0.19377²*−0.57821)−(0.61987²*0.007010²))
radical=Sqrt((0.147639*−0.57821)−(0.38424*0.0375468*−0.57821)−(0.384239*0.00004914))
radical=Sqrt(0.0853666+0.0083418−0.00001888)
radical=Sqrt(0.093689)=0.3060
firstXterm=(b²*planar_const)/scale=(0.19377²*−0.007010)/0.42179=−0.000624
secondXterm=((b*radical)/scale)=(0.19377*0.30609)/0.42179=0.14062
So
x=(−planar_const+firstXterm−secondXterm)/a=(0.007010+−0.000624−0.14062)/0.61987=−0.22555
y=(−(b*planar_const)+rad)/scale=(−(0.19377*−0.007010)+0.30609)/0.42179=0.7289
lon=a tan2(y, x)=a tan2(0.7289, −0.22555)=a tan(−3.2316)+180=−72.806+180=107.194
OR
x=(−planar_const+firstXterm+secondXterm)/a=(0.007010+−0.000624+0.14062)/0.61987=0.237156
y=(−(b*planar_const)−rad)/scale=(−(0.19377*−0.007010)−0.30609)0.42179=−0.72247
lon=a tan2(y, x)=a tan2(−0.72247, 0.237156)=a tan(−3.0464)=−71.827
On the Other Side of the Orbit Let:
planar_const=czₚ+d=(0.10030*0.64945)+0.0727=0.06514+0.0727=0.13784
radical=Sqrt((−a⁴*sphere_const)−(a²*b²*sphere_const)−(a²*planar_const²))
radical=Sqrt((−0.61987⁴*−0.57821)−(0.61987²*0.19377²*−0.57821)−(0.61987²*0.13784))
radical=Sqrt((0.147639*−0.57821)−(0.38424*0.0375468*−0.57821)−(0.384239*0.0189998))
radical=Sqrt(0.0853666+0.0083418−0.0073005)
radical=Sqrt(0.086408)=0.29395
firstXterm=(b²*planar_const)/scale=(0.19377²*0.13784)/0.42179=0.01227
secondXterm=((b*radical)/scale)=(0.19377*0.29395)/0.42179=0.13504
So
x=(−planar_const+firstXterm−secondXterm)/a=(−0.13784+0.01227−0.13504)/0.61987=−0.42043
y=(−(b*planar_const)+radical)/scale=(−(0.19377*0.13784)+0.29395)/0.42179=0.633587
lon=a tan2(y, x)=a tan2(0.633587, −0.42043)=a tan(−1.506998)+180=−56.43+180=123.567
OR
x=(−planar_const+firstX+secondX)/a=(−0.13784+0.01227+0.13504)/0.61987=0.015277396
y=(−(b*planar_const)−radical)/scale=(−(0.19377*0.13784)−0.29395)/0.42179=−0.76023
lon=a tan2(y, x)=a tan2(−0.)=a tan(−49.762)=−88.849

The points we're looking for are the closest two. That's (40.5, −88.85) to the West and (40.5, −71.83) to the East. The other two are where the edge planes intersect the latitude plane on the other side of the sphere. The sensor sees those points on the edge of the swath sometime prior to, or after, it sees the point of interest and a correction for the rotation of the Earth could be introduced here for increased accuracy. But the error is small so we skip that step here.

6) Find Crossings for the Extreme Orbits:

The longitudinal distance from the point of interest (40.5, −80.22) to the swath edges is 8.63 degrees to the west and 8.39 degrees to the east. So if the satellite were to pass over the point 8.63 degrees east of Pittsburgh (40.5, −71.59) the sensor would see Pittsburgh on the west edge of the swath. And if the satellite were to pass over the point 8.39 degrees west of Pittsburgh (40.5, −88.61) the sensor would see Pittsburgh on the east edge of the swath. We have only to find the equatorial crossings for those two orbits and we'll know the range of crossings for which the sensor is guaranteed to see Pittsburgh somewhere in the scan on the ascending pass.

To Find Those Crossings We Use the Same Method as Above:
sin(θ)=sin(90−Lat_{inf})/sin(90−Latₚ)
sin(θ)=sin(8.78)/sin(49.5)=0.15264/0.76041=0.2007
θ=11.5779
Lonₙₑ=a sin(sin(θ)*sin(Latₑ)/sin(Lat_{inf}))+Lonₑ
Lonₙₑ=a sin(0.2007*sin(40.5)/sin(81.22))−71.59
Lonₙₑ=a sin(0.2007*0.64945/0.98828)−71.59
Lonₙₑ=a sin(0.13189)−71.59
Lonₙₑ=7.57883−71.59=−64.01
RealLonₙₑ=Lonₙₑ+2.88=−64.01+2.88=−61.13

[image]

Lon_{nw}=a sin(sin(θ)*sin(Lat_{w})/sin(Lat_{inf}))+Lon_{w}
Lon_{nw}=a sin(0.2007*sin(40.5)/sin(81.22))−88.61
Lon_{nw}=a sin(0.2007*0.64945/0.98828)−88.61
Lon_{nw}=a sin(0.13189)−88.61
Lon_{nw}=7.57883−88.61=−81.03
RealLon_{nw}=Lon_{nw}+2.88=−81.03+2.88=−78.14

[image]

And we're done. For any orbit with an ascending crossing in the range [−78.14, −61,1] the sensor will see Pittsburgh on the ascending pass.

Descending Passes:

The angle θ is found the same way but finding the ascending nodal crossing is slightly different.
lonₙ=180+lonₚ−a sin(sin(θ)*sin(latₚ)/sin(lat_{inf}))
lonₙ=180−80.22−a sin(sin(11.5779)*sin(40.5)/sin(81.22))
lonₙ=180−80.22−a sin(0.2007*0.6495/0.98828)
lonₙ=180−80.22−a sin(0.1319)
lonₙ=180−80.22−7.5794
lonₙ=92.2006

We then find the length of the arc between (0, lonₙ+180) and (latₚ, lonₚ)
length=a sin(sin(latₚ)/sin(lat_{inf}))
length=a sin(sin(40.5)/sin(81.22))
length=a sin(0.64945/0.98828)
length=a sin(0.65715)
length=41.0830 degrees.

So the length of the arc between (0, lonₙ) and (latₚ, lonₚ) is (180—length) and the true equatorial crossing may be found by adjusting for the rotation of the Earth during the time it takes the satellite to travel that distance.
RealLonₙ=lonₙ+[period*(180−length)*ROTATION_RATE/circumference]
RealLonₙ=lonₙ+[period*(180−length)*ROTATION_RATE/circumference]
RealLonn=92.2006+[101*138.917*(15/60)/360]
RealLonₙ=92.2006+9.7435=101.9441
Correcting the Longitudinal Swath Widths:

A “small circle” on a sphere is any circle that is not a great circle. The radius of the small circle that defines the swath edge is proportional to the radius of the sphere by the cos of the distance from the parallel great circle. That is: radius_{sc}=radius*cos(distance) In this example the swath width is 12.6126 degrees and we're using a radius of 1. So radius_{sc}=1*cos(6.3063)=0.99395.

The Distance Between Two Points in Cartesian Space is Sqrt((x₁−x₂)²+(y₁−y₂)²+(z₁−z₂)²) So the Distance Between Left Edge Point and the West Edge Point is:
Sqrt((x_{left}−x_{west})²+(y_{left}−y_{west})²+(z_{left}−z_{west})²)=Sqrt((0.02479−0.01528)²+(−0.77722+0.76023)²+(0.62874−0.64945)²)=Sqrt((0.00951)²+(−0.01699)²+(−0.02071)²)=Sqrt(0.00009044+0.00028866+0.0004289)=Sqrt(0.000808)=0.028425

Those two points, and the center of the small circle, create an isosceles triangle in the plane of the small circle. We can use ordinary Euclidean trigonometry to find the vertex angle of that triangle and hence the length of the arc on the small circle.
cos(v)=(2r_{sc}²−D²)/2r_{sc}²=1−(D²/2r_{sc}²)=1−(0.000808/1.97587)=1−0.0004089=0.99959
i v=a cos(0.99959)=1.63862 degrees

The correction would be the distance the earth rotated in the time it took the satellite to go 1.63862 degrees
101*1.63862*(15/60)/360=0.11493 degrees

Which would give us a west distance of 8.74 instead of 8.63

Similarly to the right/east the distance between the right edge point and the east edge point is:
Sqrt((x_{right}−xₑₐₛₜ)²+(y_{right}−yₑₐₛₜ)²+(z_{right}−zₑₐₛₜ)²)=Sqrt((0.23195−0.237156)²+(−0.71247+0.72247)²+(0.66225−0.64945)²)=Sqrt((0.005206)²+(0.01)²+(0.0128)²)=Sqrt(0.0000271+0.0001+0.00016384)=Sqrt(0.00029094)=0.017057
cos(v)=(2r²−D²)/2r²=1−(D²/2r²)=1−(0.00029094/1.97587)=1−0.000147246=0.999853
v=a cos(0.999853)=0.9832 degrees

The correction would be the distance the earth rotated in the time is took the satellite to go 0.9832 degrees
101*0.9832*(15/60)/360=0.06896 degrees

Which would give us an east distance of 8.32 instead of 8.39

We claim:

1. A method of retrieving records matching specific search criteria identifying a point on the globe from an information storage system containing records describing images acquired by a satellite born sensor, comprising:
(a) Indexing the records in the information storage system to a unique crossing longitude of a reference latitude that is correlated with the information in the records.
(b) Determining the exact range of longitudinal crossings of the reference latitude that assures the sensor saw the specified point;
(c) Retrieving record locators with indexed crossings that fall within the derived longitude intervals.

2. The method of claim 1 used to retrieve records for which the sensor saw the specified point during the ascending pass of the satellite.

3. The method of claim 1 used to retrieve records for which the sensor saw the specified point during the descending pass of the satellite.

4. The method of claim 1 where the sensor is downward looking

5. The method of claim 1 where the sensor is forward or backward looking.

6. The method of claim 1 where the sensor is side viewing

7. The method of claim 1 corrected for the rotation of the Earth during the interval between the time the satellite crosses the latitude of the specified point and the time the sensor sees the specified point.

8. The method of claim 1 compensated to work with records describing partial orbits.

9. The method of claim 1 compensated to work with records describing multiple orbits.

10. The method of claim 1 compensated to work with search criteria identifying an area on the globe by breaking the area into a set of representative points.

11. A method for determining the longitudinal crossing of a reference latitude for a satellite in a circular orbit that is asserted to have passed over a given point of interest comprising:
a) Using the inclination and period of the satellite to model the orbit as a great circle under which the Earth rotates;
b) Constructing a spherical triangle on a static sphere with vertices at the point of interest, the appropriate pole, and the inflection point;
c) Constructing a similar spherical triangle on a static sphere with vertices at the point of interest, the relevant point at which the meridian that passes through the point of interest crosses the equator, and the point at which the orbit crosses the equator;
d) Using the relationships between the similar spherical triangles to determine the longitude of the point at which the orbit crosses the equator on a static sphere;
e) Using the now well-defined great circle that includes both the point of interest and the equator crossing to determine the longitude of the point at which the orbit crosses the reference latitude;
f) Calculating the interval between the time the satellite crossed the reference latitude and the time it passed over the point of interest to correct the crossing longitude for the rotation of the Earth.
